(19) United States
(12) Patent Application Publication
(10) Pub. No.: US 2026/0012111 A1
(43) Pub. Date: Jan. 8, 2026

(54) Method for Operating a Position Sensorless BLDC Motor of an Oil Pump, Computer Program, Computer Program Product, Heat-Transfer Medium System, and Vehicle

(71) Applicant: Vitesco Technologies GmbH, Regensburg (DE)

(72) Inventors: Gerhard Eser, Hemau (DE); Sebastian Brettner, Burglengenfeld (DE); Manuel Dillinger, Kelheim (DE); Markus Feulner, Ensdorf (DE); Christian Böhm, Bad Vilbel (DE)

(73) Assignee: Vitesco Technologies GmbH, Regensburg (DE)

(21) Appl. No.: 18/862,679

(22) PCT Filed: May 4, 2023
(86) PCT No.: PCT/EP2023/061850

§ 371 Date: Jul. 16, 2025

(30) Foreign Application Priority Data
May 5, 2022 (DE) 10 2022 204 447.9

(51) Int. Cl. H02P 6/08; B60K 11/02; H02K 7/14; H02K 9/19; H02P 29/68

(52) U.S. Cl. CPC H02P 6/08; B60K 11/02; H02K 7/14; H02K 9/19; H02P 29/68; H02P 2207/05; H02P 2209/07; H02P 2209/11

(57) ABSTRACT

A method for operating a position-sensorless BLDC motor of an oil pump (19) is proposed. When the oil pump (19) is put into operation and run up to speed, to warm an oil that is transported by the oil pump (19), the BLDC motor is operated in a pre-controlled-excited mode until the oil has a kinematic viscosity that allows the BLDC motor to be operated in a controlled mode above a motor-specific limiting speed of a rotor of the BLDC motor. Waste heat of the BLDC motor generated by the pre-control is in this case dissipated to the oil in the surrounding area of the oil pump (19).

This pre-control is intermittently interrupted in order to detect a voltage induced by the rotor in the unexcited coils of a stator of the BLDC motor, by means of which a rotor position and a rotor (rotational) speed are determined sufficiently accurately above the limiting speed of the rotor.

Above this limiting speed, once it is detected that it has been exceeded, a changeover is made to a controlled-excited mode of the BLDC motor.

Also proposed are a computer program, a computer program product, a heat-transfer medium system and a vehicle.

The present invention relates to a method for operating a position-sensorless BLDC motor of an oil pump of an oil circuit of an electric drive, in particular for driving a vehicle. The present invention also relates to a computer program and to a computer program product which respectively replicate the proposed method. The present invention also relates to a heat-transfer medium system for an electric drive, in particular for driving a vehicle, and to a vehicle with such a heat-transfer medium system.

An electric motor or electric drive, in particular for driving a vehicle, may be of a liquid-cooled design. A water-based cooling liquid, such as for instance a water-glycol mixture, of a cooling-liquid circuit and/or an oil of an oil cooling circuit may be used as the cooling liquid here.

A distinction is made below between water-based cooling-liquid cooling or a water-based cooling-liquid cycle (circuit) and oil cooling or an oil cooling cycle (circuit).

The object of the present invention is to improve an oil cooling circuit of an electric motor, in particular for driving a vehicle.

This object is achieved by a method with the features of claim 1. Claims 6 and 7 afford protection to a computer program and a computer program product. Claims 8 and 9 afford protection to a heat-transfer medium system for an electric drive and to a vehicle. The dependent claims relate to advantageous developments.

A method for operating a position-sensorless BLDC motor of an oil pump of an oil cooling circuit of an electric drive, in particular for driving a vehicle, is proposed.

When the oil pump is put into operation and run up to speed—i.e. after each switching off or switching-off operation and switching on or switching-on operation of the oil pump—to warm an oil that is transported by oil pump, the BLDC motor is operated in a pre-controlled-excited mode until the oil has a kinematic viscosity that allows the BLDC motor to be operated in a controlled-excited mode above a motor-specific limiting speed of a rotor of the BLDC motor. Waste heat of the BLDC motor generated by the pre-control is in this case dissipated to the oil in the surrounding area of the oil pump and the oil is thereby successively warmed.

In this case, a temperature of a warming controller of the BLDC motor is also monitored by sensors in order to be able to avoid overheating of the controller.

The pre-control of the BLDC motor is in this case intermittently interrupted in order to detect a voltage induced by the rotor in the unexcited coils of a stator of the BLDC motor, by means of which a rotor position and a rotor (rotational) speed can be determined sufficiently accurately above the limiting speed of the rotor.

Finally, above the limiting speed, once it is detected that it has been exceeded, a changeover is made to the controlled-excited mode of the BLDC motor in order to operate the BLDC motor efficiently.

A BLDC motor is a so-called brushless DC motor (BLDC or BL motor for short) and also an electronically commutated motor (EC motor for short), in which a rotating electric field that can be generated in the windings of a three-phase stator turns or rotates synchronously with a rotor fitted with permanent magnets which is drawn through the rotating field.

A pre-controlled-excited mode of the BLDC motor should be understood as meaning a controlled excitation of coils of a stator of the BLDC motor for generating a rotating electric field in order to operate a rotor in a pre-controlled manner to draw it above a definable or motor-specific limiting speed, while its position relative to the coils below the limiting speed is unknown.

Below the limiting speed, a rotor position and a rotor (rotational) speed cannot be determined sufficiently accurately by means of said voltage induced by the rotor.

The voltage induced by the rotor should in this case be understood as meaning a so-called back electromotive force (back EMF). As is known, this should be understood as meaning a secondary voltage which for its part generates a secondary magnetic field, which opposes the natural motion of the motor. As from a motor-specific limiting speed, this secondary voltage can be clearly detected here in the individual phases of the BLDC motor—which are unexcited during an electronic commutating sequence—and used for determining or ascertaining a rotor position and also a rotor (rotational) speed.

As is known, in each of the six stages of the commutating sequence of a so-called three-phase BLDC motor, a first phase or phase winding excites positively and a second phase or phase winding excites negatively, while a third phase or phase winding remains unexcited.

Said secondary voltage is in this case proportional to the rotor (rotational) speed or to the angular speed of the rotor. It acts counter to the supply voltage which the rotating field generates in the individual winding sections of the stator, and reduces it correspondingly.

Said limiting speed of the rotor may be, motor-specifically, approximately 800 rpm. The controller of the BLDC motor is in this case designed for an operating temperature range of −40° C. to 125° C. (automobile temperature range).

Consequently, the proposed method advantageously assists warming of the oil transported by the oil pump, which, as is known, has a very high kinematic viscosity at low temperatures, i.e. at temperatures of −40° C.≤T≤0° C., and because of this is found to be very viscous.

It is in this case proposed that, when a definable limiting temperature of the controller is exceeded below the limiting speed of the rotor, a pre-controlled rotating electric field is interrupted to protect the controller from overheating, and after that the controller waits until its temperature decreases by a definable value before pre-controlled excitation is resumed.

It is in this case proposed to advantageously provide or specify a temperature delta for this temperature decrease in such a way that, when ambient temperature conditions cause the BLDC motor to undergo repeated pre-control, a number of such pre-control phases-in a sequence of such pre-control phases and intermittent interruption phases—can be reduced to a minimum. This allows on the one hand a desired heat input into the oil to be brought about and on the other hand thermal loading of the controller up to its limiting temperature to be reduced to a minimum.

It is also proposed that a number of such pre-control phases—in a sequence of such pre-control phases and intermittent interruption phases—is limited to a maximum number with respect to a definable time period, dependent on an ambient temperature.

This also contributes to reducing to a minimum thermal loading of the controller up to its limiting temperature.

In one embodiment, above the limiting speed of the rotor, the rotor position and the rotor (rotational) speed can be estimated or determined or ascertained by estimation by means of a voltage induced sinusoidally in the coils or in the individual phases of the BLDC motor.

In a further embodiment, above the limiting speed of the rotor, the rotor position and the rotor (rotational) speed can be estimated or determined or ascertained by estimation by means of a voltage induced trapezoidally in the coils or in the individual phases of the BLDC motor.

A computer program for carrying out the method described above is also proposed.

Also proposed is a computer program product, comprising program code means which are stored on a computer-readable data storage medium in order to carry out the method described above when the program code means are executed on a computer.

Additionally proposed is a heat-transfer medium system for an electric drive, in particular for driving a vehicle, which has at least one cooling-liquid circuit and also an oil cooling circuit, the oil cooling circuit having an electrically operated oil pump—with a BLDC motor—with a controller with a computer program product of the type described above.

Moreover, a vehicle with a heat-transfer medium system of the type described above is proposed.

The vehicle may in this case be a battery electric vehicle (BEV for short), a hybrid electric vehicle (HEV for short) or a fuel cell electric vehicle (FCEV for short).

Further advantages and features emerge from the dependent claims and the exemplary embodiments. In this respect:

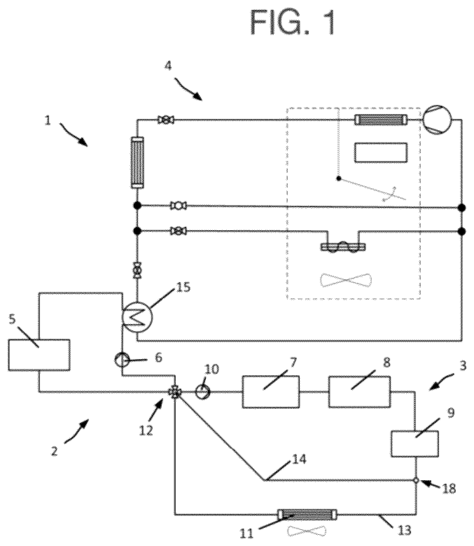

FIG. 1: shows heat-transfer medium circuits of a thermal management system of a vehicle;

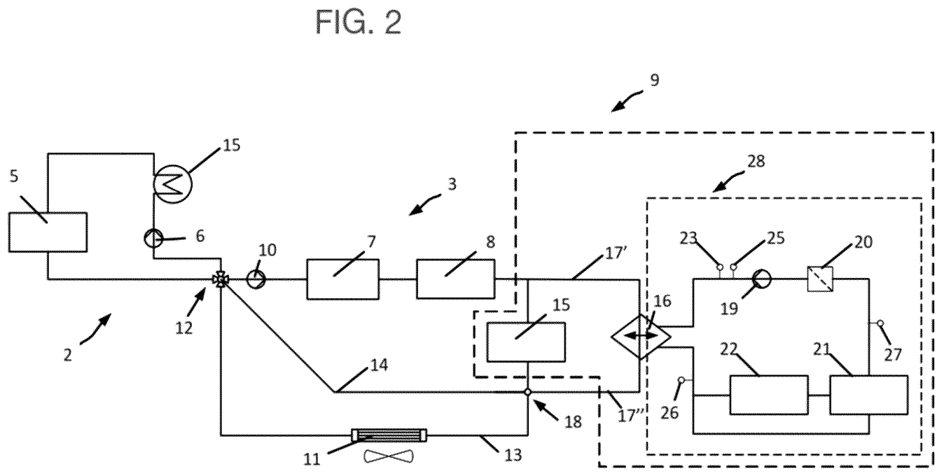

FIG. 2: shows the lower part of the system illustrated in FIG. 1 in a further representation; and

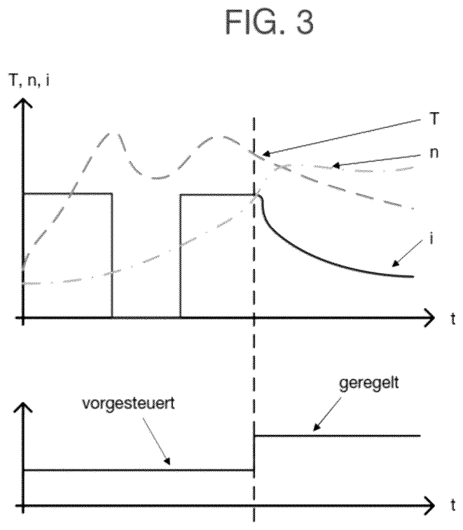

FIG. 3: shows a qualitative representation of various parameter profiles of a BLDC motor of an oil pump.

The thermal management system or heat-transfer medium system 1 illustrated in FIG. 1 comprises a cooling-liquid cycle or cooling-liquid circuit 2 for a battery 5, a cooling-liquid cycle or cooling-liquid circuit 3 for an electric motor or electric drive 9 for driving the vehicle and also a refrigerant cycle or refrigerant circuit 4 of an air-conditioning system. The cooling-liquid circuit 2 is in this case thermally connected to the refrigerant circuit 4 by way of a heat exchanger 15—also referred to as a chiller.

In these two cooling-liquid circuits 2, 3, which can be connected to one another or can be separated from one another by way of a so-called multi-way valve unit, for instance in the form of a 5/3-way valve 12, a cooling liquid is transported or circulated by means of its own electric pump or an electric pump 6, 10 assigned to the respective cooling-liquid circuit 2, 3. The 5/3-way valve 12 in this case also advantageously allows so-called mixed states between the cooling-liquid circuits 2, 3 to be established.

The cooling-liquid circuit 3 also comprises upstream of the electric drive 9 a charger 7 and also a power electronics system 8. Downstream of the motor 9 there is a junction or branching point 18, by way of which on the one hand a bypass path 14 and on the other hand a radiator path 13 lead back to said multi-way valve 12 by way of a radiator or cooler 11.

The electric drive 9 and the power electronics system 8 should be operated at a cooling-liquid or cooling-water temperature of approximately 80 to a maximum of 85° C. In this case, the cooling liquid has a temperature of approximately 55° C. at the inlet to the power electronics system 8 and a temperature of approximately 65° C. at the inlet to the electric motor 9. At the outlet of the electric motor 9, the cooling liquid then has a temperature of approximately 80 to a maximum of 85° C.

By contrast, the battery 5 or the individual battery cells should be operated at a cooling-liquid or cooling-water temperature at the output of the battery 5 of approximately 20° C. to approximately 40° C. because this ensures an optimal operating temperature range for the battery 5. Both cooling-liquid circuits 2, 3 must be able to both absorb and dissipate heat.

A water-based cooling liquid should be understood here as meaning a mixture of water with a coolant additive. The task of the cooling liquid here is not only to absorb and transport waste heat. The coolant additive is also intended here to protect the water from freezing through, to protect the two cooling-liquid circuits from corrosion, to lubricate the moving parts in the two cooling-liquid circuits and also to protect both plastic and/or rubber elements in the two cooling-liquid circuits from dissolving. The cooling liquid may be for example a so-called water-glycol mixture.

The electric drive 9 is both cooling-liquid-cooled and oil-cooled. FIG. 2 illustrates cooling-liquid cooling of a stator 15 of the electric drive 9 and also oil cooling for additional cooling of the electric drive 9. The stator 15 is in this case enclosed by the cooling-liquid circuit 3, while the rotor 22 of the electric drive 9 is enclosed by the oil cooling circuit 28. The oil cooling circuit 28 is in this case thermally connected to the cooling-liquid circuit 3 upstream and downstream of the stator 15 by way of a heat exchanger 16 and the two line sections 17′, 17″.

The oil cooling circuit 28 also comprises a transmission or a stepdown transmission 21, for example in the form of a one-, two-or three-stage transmission, which with the electric drive 9, 15, 22 forms an electric-motor/transmission drive unit. The oil circuit 28 also comprises an electrically operated oil pump 19 with a BLDC motor, an oil filter 20 fluidically connected upstream of the oil pump 19, two temperature sensors 26, 27 and also two pressure sensors 23, 25. The pressure sensors 23, 25 are in this case arranged downstream of the oil pump 19 and upstream of the heat exchanger 16 or between the oil pump 19 and the heat exchanger 16, whereas a temperature sensor 26 is arranged downstream of the heat exchanger 16 and upstream of the rotor 22 and a further temperature sensor 27 is arranged downstream of the transmission 21 and upstream of the oil filter 20. In this way, both the oil flow and the temperature in the oil cooling circuit 28 can be correspondingly monitored and controlled in an open-loop and/or closed-loop manner.

Waste heat from the electric drive 9 that is absorbed by the oil cooling circuit 28 is fed by way of the heat exchanger 16 to the cooling-liquid circuit 3. In this case, the heat exchanger 16 is arranged fluidically parallel to the stator 15. A first feed line 17′ in this case leads from a junction of the cooling-liquid circuit 3 upstream of the stator 15 to the heat exchanger 16 and a second feed line 17″ leads from the heat exchanger 16 to said junction 18 downstream of the stator 15.

The oil transported, which is also used for lubricating and cooling the transmission 21, is passed through a shaft of the rotor 22 to at least one outlet point of the rotor 22. From this outlet point, the oil is forced or sprayed against the windings of the stator 15 as a result of centrifugal force, with the oil being distributed over the rotor 22 and in this case also reaching the two bearing points of the rotor shaft. The oil finally flows into an oil pan-not shown here-which is attached to the stator 15. The oil pump 19 sucks in the oil from this oil pan and transports it into the oil-cooling circuit 28. Here, the oil cools the electric motor 9 in addition to the cooling liquid of the cooling-liquid circuit 3 by absorbing the waste heat from the stator 15 and the rotor 22 and dissipating it by way of the heat exchanger 16 to the cooling-liquid circuit 3.

In the following text, a method for operating a position-sensorless BLDC motor of the oil pump 19 is proposed. In this case, when the oil pump 19 is put into operation—i.e. after a switching-off operation and a then-following switching-on operation of the oil pump 19—and for running it up to speed, at low temperatures, i.e. at temperatures of −40° C.≤T≤0° C., at which the oil transported is found to be very viscous because of the temperature—on account of a high kinematic viscosity—the BLDC motor is operated as follows to warm the oil in the surrounding area of the BLDC motor that is transported by the oil pump 19.

To illustrate this running up to speed of the oil pump 19 and the proposed operating method, reference is made here to FIG. 3, which shows profiles of the variation in quality over time of various parameters of the BLDC motor during a pre-controlled mode (pre-control phase) of the BLDC motor and during a then-following controlled mode (control phase) of the BLDC motor. A monitored temperature T of a controller of the BLDC motor, a rotational speed n of a rotor of the BLDC motor and also a current consumption i of the BLDC motor are illustrated here.

For the running up to speed of the oil pump 19, the coils of the stator of the BLDC motor are first excited in a pre-controlled manner to generate a rotating electric field in order to draw or drive the rotor of the BLDC motor. Below a motor-specific limiting speed of the rotor—of approximately 800 rpm—a position of the rotor relative to the coils is unknown. The waste heat from the BLDC motor that is generated during the pre-control of the rotating field is dissipated to the oil in the surrounding area of the oil pump 19 or of the BLDC motor of the oil pump 19.

During such pre-control of the rotating field or such a pre-controlled-excited mode of the BLDC motor—also referred to as operating the BLDC motor with an open loop—an inefficient way of operating the BLDC motor in comparison with a controlled mode of the BLDC motor—also referred to as operating the BLDC motor with a closed loop—is accepted (cf. in this respect the increased current consumption i of the BLDC motor during the pre-control; FIG. 3). Increased losses in this case cause warming in particular of the stator of the BLDC motor, the waste heat of which is used for the purpose of successively warming the oil transported.

To be able to establish when the limiting speed of the rotor is exceeded, the pre-controlled rotating field is intermittently interrupted, so that a voltage induced by the rotor in the unexcited coils can be detected. What is meant by this is the back electromotive force (EMF for short) described at the beginning. This is so because, above the limiting speed of the rotor, the voltages induced in the individual phases of the stator winding are sufficiently high, and consequently can be sensed sufficiently accurately. By means of these induced voltages, a rotor position and also a rotor (rotational) speed are then determined or ascertained sufficiently accurately by estimation.

During the pre-control, the temperature T of the warming controller of the BLDC motor is monitored by sensors, for instance by means of a temperature sensor on a circuit board of the controller.

If during the pre-control a limiting temperature of the controller of for example 125° C. is exceeded below said limiting speed of the rotor, the pre-controlled rotating electric field is interrupted to protect the controller from overheating, and after that the controller waits until its temperature decreases by a definable value (temperature delta) before pre-controlled excitation of the BLDC motor is resumed.

The temperature value that can be specified for the temperature decrease (temperature delta) should not be chosen too small here in order to be able to minimize as much as possible a number of required pre-control and interruption phases caused by ambient temperature conditions.

Depending on the ambient temperature or temperature of the oil transported, it may be required to pre-control the rotating field repeatedly, and intermittently interrupt it correspondingly, until the oil transported is sufficiently warmed and has a kinematic viscosity, from which the rotor finally exceeds said limiting speed, from which the controlled mode of the BLDC motor is made possible.

Once the rotor exceeds said limiting speed—of approximately 800 rpm—a changeover is made to controlled excitation of the BLDC motor (cf. in this respect operating modes in the lower part of FIG. 3).

By using said estimation of the rotor position and of the rotor (rotational) speed, a desired coil excitation frequency or a rotor (rotational) speed can then be specified and controlled in a so-called PLL control structure (Phase Locked Loop).

1. A method for operating a position-sensorless BLDC motor of an oil pump (19) which, when the oil pump (19) is put into operation and run up to speed, to warm an oil that is transported by the oil pump (19), is operated in a pre-controlled-excited mode until the oil has a kinematic viscosity that allows the BLDC motor to be operated in a controlled-excited mode above a motor-specific limiting speed of a rotor of the BLDC motor, waste heat of the BLDC motor generated by the pre-control being dissipated to the oil in the surrounding area of the oil pump (19),
wherein a temperature of a warming controller of the BLDC motor is monitored by sensors,
wherein the pre-control is intermittently interrupted in order to detect a voltage induced by the rotor in the unexcited coils of a stator of the BLDC motor, by means of which a rotor position and a rotor (rotational) speed are determined sufficiently accurately above the limiting speed of the rotor,
wherein, above the limiting speed, once it is detected that it has been exceeded, a changeover is made to the controlled-excited mode of the BLDC motor.

2. The method as claimed in claim 1, wherein, when a definable limiting temperature of the controller is exceeded below the limiting speed of the rotor, a pre-controlled rotating electric field is interrupted to protect the controller from overheating, and after that the controller waits until its temperature decreases by a definable value before pre-controlled excitation is resumed.

3. The method as claimed in claim 2, wherein a number of such pre-control phases—in a sequence of such pre-control phases and intermittent interruption phases—is limited to a maximum number with respect to a definable time period, dependent on an ambient temperature.

4. The method as claimed in one of the preceding claims 1 to 3, wherein, above the limiting speed of the rotor, the rotor position and the rotor (rotational) speed are determined by means of a voltage induced sinusoidally in the coils.

5. The method as claimed in one of the preceding claims 1 to 3, wherein, above the limiting speed of the rotor, the rotor position and the rotor (rotational) speed can be determined by means of a voltage induced trapezoidally in the coils.

6. A computer program for carrying out a method as claimed in one of claims 1 to 5.

7. A computer program product, comprising program code means, which are stored on a computer-readable data storage medium, in order to carry out the method as claimed in one of claims 1 to 5 when the program code means are executed on a computer.

8. A heat-transfer medium system for an electric drive (9, 15, 22), in particular for driving a vehicle, which has at least one cooling-liquid circuit (3) and also an oil cooling circuit (28), the oil cooling circuit (28) having an electrically operated oil pump (19) with a BLDC motor and a controller with a computer program product as claimed in claim 6.

9. A vehicle with a heat-transfer medium system as claimed in claim 8.
